(19) United States
(12) Patent Application Publication
(10) Pub. No.: US 2013/0144778 A1
(43) Pub. Date: Jun. 6, 2013

(54) GPS-BASED PORTABLE GOLF DISTANCE INDICATOR AND METHOD FOR SHARING MAP DATA USING THE SAME

(71) Applicant: Misook JO, Seoul (KR)

(72) Inventor: Misook JO, Seoul (KR)

(21) Appl. No.: 13/311,245

(22) Filed: Dec. 5, 2011

(51) Int. Cl. A63B 57/00; G06Q 40/00

(52) U.S. Cl. 705/39; 473/407; 473/409

(57) ABSTRACT

A GPS-based portable golf distance indicator and a method for sharing map data using the same. The GPS-based portable golf distance indicator includes a GPS receiver for receiving a GPS signal from a GPS satellite and outputting coordinate data of a current location based on the received GPS signal, a keypad for executing a driving distance notification menu for notifying a driving distance of a ball or a distance notification menu for notifying a distance from the current location to a hole cup or selecting a location registration menu, a memory for storing map data of a golf course, a processor for calculating and controlling, and a power supply. When selecting the location registration menu, the processor receives the coordinate data of the current location from the GPS receiver and registers coordinate data of a target object location on the golf course in the map data.

### BACKGROUND OF THE INVENTION

1. Field of the Invention

The present invention relates to a Global Positioning System (GPS)-based portable golf distance indicator and a method for sharing map data using the same.

2. Discussion of the Related Art

Accurate estimation of the driving distance of a ball or the distance remaining from a current location to a hole cup on a green is essential for a good play of golf. For this purpose, a golf GPS terminal is in use, for measuring the distance between a ball and a hole cup based on GPS and notifying the measure distance.

The golf GPS terminal internally preserves a golf course map to notify the driving distance of a ball or the distance remaining from the current location of the ball to a hole cup. The golf course map includes coordinate data of important locations such as a tee box, a green, and a hole cup on each hole of the golf course. However, the coordinate data of the important locations are not highly reliable because it is acquired from the map rather than from actual measurements.

Due to a large number of existing golf courses and an increase in the number of new golf courses, manufacturers of golf GPS terminals have practical difficulty in providing users with such coordinate data on all golf courses.

Meanwhile, since the golf GPS terminal is portable and thus operates with an in-built chargeable battery, there exists a need for a method for minimizing unnecessary power consumption to operate the golf GPS terminal normally during a golf play.

In general, a golf game is played continuously from the 1^{st} to 18^{th} holes. If the golf GPS terminal locates a golfer as in the vicinity of a tee box on the next hole, it notifies the distance from the current location to a hole cup on the next hole, considering that the golfer has finished his or her play on the current hole and then started the play on the next hole. However, when the golf GPS terminal fails to detect the current location of the golfer in the vicinity of the tee box on the next hole, its distance notification may be made based on the position of the previous hole, not the position of the hole cup on the next hole, in spite of the play already in progress on the next hole.

### SUMMARY OF THE INVENTION

Accordingly, the present invention is directed to a Global Positioning System (GPS)-based portable golf distance indicator and a method for sharing map data using the same that substantially obviate one or more problems due to limitations and disadvantages of the related art.

An object of the present invention is to provide a GPS-based portable golf distance indicator for allowing a user to directly register the coordinate data of important locations on a golf course during a golf play in order to increase the reliability of the coordinate data of the important locations on the golf course.

Another object of the present invention is to provide a GPS-based portable golf distance indicator for minimizing unnecessary power consumption.

Another object of the present invention is to provide a GPS-based portable golf distance indicator for successively identifying holes on a golf course.

A further object of the present invention is to provide a method for sharing map data using a GPS-based portable golf distance indicator so that a user can share coordinate data registered through the GPS-based portable golf distance indicator with another user.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a Global Positioning System (GPS)-based portable golf distance indicator includes a GPS receiver for receiving a GPS signal from a GPS satellite and outputting coordinate data of a current location based on the received GPS signal, a keypad for executing a driving distance notification menu for notifying a driving distance of a ball or a distance notification menu for notifying a distance from the current location to a hole cup or selecting a location registration menu, a memory for storing map data of a golf course, a processor for calculating and controlling; and a power supply for supplying power to operate the GPS-based portable golf distance indicator. When the location registration menu is selected by an input of the keypad, the processor receives the coordinate data of the current location from the GPS receiver and updates the map data by registering coordinate data of a target object location on the golf course in the map data.

The target object location may be a location of a tee box or a location of a hole cup on an N^{th} hole of the golf course.

The GPS-based portable golf distance indicator may further include an audio output unit,

When the driving distance notification menu is executed by an input of the keypad, the processor may calculate the driving distance of the ball using coordinate data of a first position based on a first input and coordinate data of a second position based on a second input, generate a voice notification message related to the calculated driving distance, and output the voice notification message through the audio output unit.

The GPS-based portable golf distance indicator may further include a Universal Serial Bus (USB) interface or a wireless data transmission interface, for transmitting the map data.

The USB interface or the wireless data transmission interface may receive voice data generated in a language of at least one country, for generating the voice notification message and stores the received voice data in the memory, and upon selection of voice data generated in a language of a country from among the voice data generated in the language of the at least one country, the processor may generate the voice notification message based on the selected voice data.

The GPS-based portable golf distance indicator further may include a USB interface or a wireless data transmission interface, for transmitting the map data.

Upon expiration of a predetermined time after the processor initially determines that the current location is within a predetermined radius from a hole cup on an N^{th} hole including the current location, the processor sets the GPS-based portable golf distance indicator as moved to an (N+1)^{th} hole.

When the current location is not within a predetermined radius from the golf course, the processor may calculate an expected time to reach within the predetermined radius based on a current moving speed and set the GPS-based portable golf distance indicator in a power saving mode for the expected time.

The processor may set the GPS receiver to perform a location search in a normal mode from a time of identifying an N^{th} hole till a time of identifying an N^{th} tee box and in a power saving mode from the time of identifying the N^{th} tee box till a time of identifying an (N+1)^{th} hole, and the GPS receiver may have a shorter location search period in the normal mode than in the power saving mode.

In another aspect of the present invention, a method for sharing map data transmitted from the Global Positioning System (GPS)-based portable golf distance includes receiving the map data from a first user terminal to which the map data is transmitted via the USB interface or the wireless data transmission interface by a transceiver of the server, uploading the received map data to a map data sharing site by a processor of a server, receiving a map data transmission request signal from a second user terminal by the transceiver of the server, and transmitting the map data to the second user terminal by the transceiver of the server.

The method may further include requesting payment information to the second user terminal through the transceiver of the server by a processor of the server, processing, upon receipt of the payment information from the second user terminal at the transceiver of the server, payment using the received payment information by the processor of the server, and storing information about the processed payment in a memory of the server by the processor of the server.

The method may further include receiving log-in information from the first user terminal by the transceiver of the server, processing a log-in of the first user terminal by the processor of the server, depositing cyber money into an account corresponding to an Identifier (ID) used for the log-in of the first user terminal, based on the information about the processed payment by the processor of the server, and storing information about the deposited cyber money in the memory of the server by the processor of the server.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 illustrates a topography of a golf course referred for describing a Global Positioning System (GPS)-based portable golf distance indicator according to an embodiment of the present invention;

FIG. 2 is a block diagram of the GPS-based portable golf distance indicator according to the embodiment of the present invention;

FIG. 3 is a flowchart illustrating an operation for executing a distance notification menu in the GPS-based portable golf distance indicator according to the embodiment of the present invention;

FIG. 4 is a flowchart illustrating an operation for executing a driving distance notification menu in the GPS-based portable golf distance indicator according to the embodiment of the present invention;

FIG. 5 is a flowchart illustrating a method for registering coordinates in the GPS-based portable golf distance indicator according to the embodiment of the present invention;

FIG. 6 is a flowchart illustrating a method for saving power in the GPS-based portable golf distance indicator according to the embodiment of the present invention;

FIG. 7 illustrates the configuration of a system for performing a map data sharing method according to another embodiment of the present invention;

FIG. 8 is a block diagram of a service server for performing the map data sharing method according to the second embodiment of the present invention; and

FIG. 9 is a flowchart illustrating the map data sharing method according to the second embodiment of the present invention.

### DETAILED DESCRIPTION OF THE INVENTION

The objectives and effects of the present invention and the technical configurations of the present invention to achieve them will be apparent with reference to embodiments of the present invention described in detail with the attached drawings. A detailed description of a generally known function and structure of the present invention will be avoided lest it should obscure the subject matter of the present invention. Although the terms used in the present invention are selected from generally known and used terms, taking into account the structures, roles, and functions of the present invention, they are subject to change depending on the intention of a user or an operator or practices.

It is to be clearly understood that the present invention may be implemented in various manners, not limited to embodiments as set forth herein. The embodiments of the present invention are provided only to render the disclosure of the present invention comprehensive and indicate the scope of the present invention to those skilled in the art. The present invention is defined only by the appended claims. Accordingly, the scope of the invention should be determined by the overall description of the specification.

Through the specification, when it is said that some part “includes” a specific element, this means that the part may further include other elements, not excluding them, unless otherwise mentioned. The term “-er(or)”, “module”, “unit” or “part” is used to signify a unit of performing at least one function or operation. The unit can be realized in hardware, software, or in combination of both.

Meanwhile, in the embodiments of the present invention, each component, function block, or device may be configured with one or more lower components and its electrical, electronic and mechanical functions can be implemented with various known devices or mechanical components such as an electronic circuit, an integrated circuit, an Application Specific Integrated Circuit (ASIC), etc. Each component may be separately configured or two or more components may be incorporated into a single component.

It will be understood that each block and combinations of blocks of the attached flowchart and/or block diagram illustrations may be implemented by computer program instructions. These computer program instructions may be loaded onto a processor of a general-purpose computer, a special-purpose computer, or other programmable data processing apparatus to produce a machine, such that the instructions, which execute via the processor of the computer or other programmable data processing apparatus, create means for implementing the functions specified in the flowchart and/or block diagram block or blocks. These computer program instructions may also be stored in a computer-usable or computer-readable memory that may direct a computer or other programmable data processing apparatus to function in a particular manner, such that the instructions stored in the computer-usable or computer-readable memory produce an article of manufacture including instructions that implement the function specified in the flowchart and/or block diagram block or blocks. The computer program instructions may also be loaded onto a computer or other programmable data processing apparatus to cause a series of operational steps to be performed on the computer or other programmable data processing apparatus to produce a computer implemented process such that the instructions that execute on the computer or other programmable data processing apparatus provide steps for implementing the functions specified in the flowchart and/or block diagram block or blocks.

Each block or step may represent a module, a segment, or a portion of code, which may comprise one or more executable instructions for implementing a specified logical function or functions. It should also be noted that in some alternative embodiments, the functions noted in the blocks or steps occur out of the order. For example, two block or steps shown in succession may, in fact, be executed substantially concurrently or the blocks or steps may be sometimes executed in the reverse order, depending on the functionality involved.

Now a description will be given of a Global Positioning System (GPS)-based portable golf distance indicator according to an embodiment of the present invention.

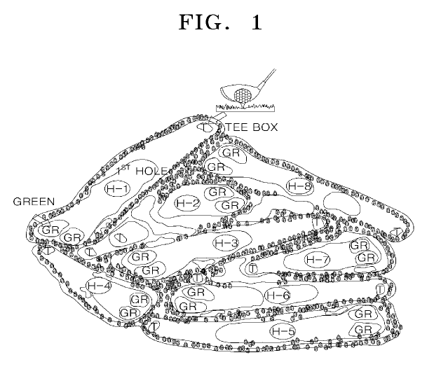

FIG. 1 illustrates a topography of a golf course referred to for describing a GPS-based portable golf distance indicator according to an embodiment of the present invention.

A “golf course” is a field in which golf is played. The golf course is divided into separate fields of play called “holes”. Golf courses are designed with 9, 18, 27, 36, 54, or 72 holes. One round of golf typically consists of 18 holes, specifically 4 par-3 short holes, 10 par-4 middle holes, and 4 par-5 long holes.

As illustrated in FIG. 1, each of the holes on a golf course begins on a tee box where a golfer hits his or her first shot. One hole has usually three or more tee boxes and, when needed, five tee boxes.

Tee boxes are classified into a champion tee, a regular tee, a front tee, a ladies tee, etc. according to their distances to a hole cup. Tee boxes vary in area or shape depending on weather, terrain, soil, grass types, and the number of visitors. The champion tee is the farthest and the ladies tee is the shortest, from the green. In general, professional golfers tee off from the champion tee, amateur golfers tee off from the regular tee or the front tee, and women golfers tee off from the ladies tee.

Each hole includes a left/right green where a hole cup is placed, as illustrated in FIG. 1.

When golfers play golf on such a golf course, the distance from a tee box to a hole cup, the distance from the location of a ball hit from the tee box to the hole cup, etc. are key factors in playing golf. That is, what club to take a shot with, how much force to exert on the shot, and how to swing the golf club are determined according to the distance remaining to the hole cup.

The following description is given of embodiments of the present invention with the appreciation that target object positions whose coordinates are to be registered are the positions of a tee box and a hole cup on a left/right green.

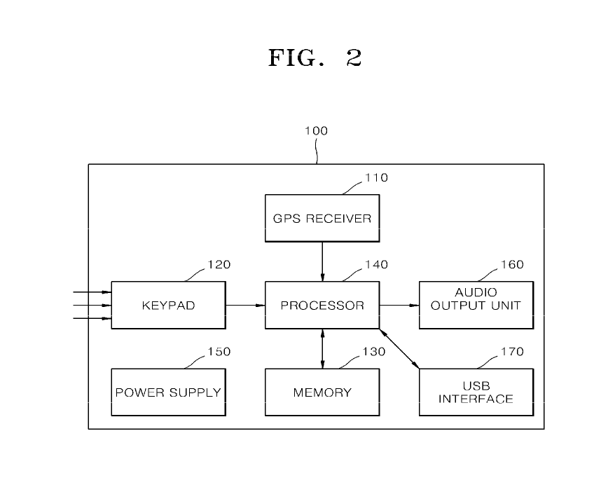

FIG. 2 is a block diagram of a GPS-based portable golf distance indicator according to an embodiment of the present invention.

Referring to FIG. 2, a GPS-based portable golf distance indicator 100 includes a GPS receiver 110 for receiving a GPS signal from a GPS satellite and outputting the coordinates of a current location, a keypad 120 for executing a distance notification menu for notifying the distance from a current location to a hole cup or a driving distance notification menu for notifying the driving distance of a golf ball, or executing a location registration menu for registering position information on a golf course, a memory 130 for storing operating program and a data, e.g, a map data of the golf course, a processor 140 for calculations and control, a power supply 150 for supplying power to operate the GPS-based portable golf distance indicator 100, an audio output unit 160 for outputting a voice notification message, and a Universal Serial Bus (USB) interface 170 for transmitting map data to another device such as a PC.

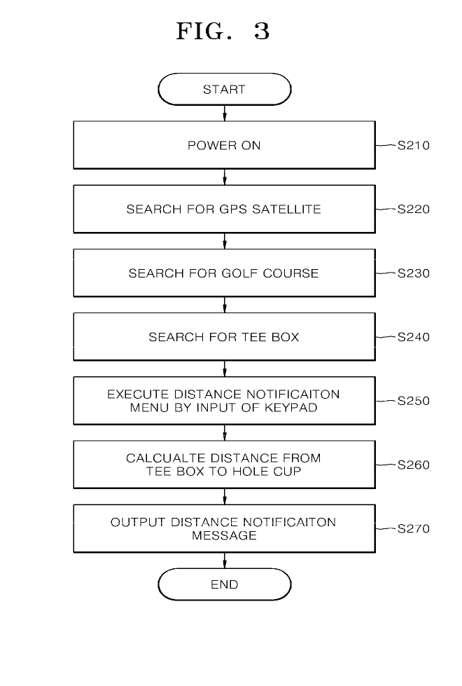

FIG. 3 is a flowchart illustrating an operation for executing a distance notification menu in the GPS-based portable golf distance indicator according to the embodiment of the present invention.

Referring to FIG. 3, when a user presses the keypad 120, the GPS-based portable golf distance indicator 100 is powered on in response to the input of the keypad 120 (S210).

Upon power-on, the GPS receiver 110 searches for a GPS satellite (S220). Then, the processor 140 receives coordinate data of a current location from the GPS receiver 110 and searches for a golf course where the GPS-based portable golf distance indicator 100 is currently located based on the received coordinate data and the map data (S230).

When the golf course is detected, the processor 140 receives coordinate data of a current location from the GPS receiver 110 and searches for a tee box on a specific hole in the detected golf course (S240). When the user executes the distance notification menu by pressing the keypad 120 after the processor 140 detects the tee box (S250), the processor 140 calculates the distance from the tee box to a hole cup using coordinate data of the tee box and coordinate data of the hole cup in the map data (S260) and generates a distance notification message and outputs the distance notification message through the audio output unit 160 (S270). The distance notification message may say, for example, “You have xxx meters to go on an n^{th} hole” or “You have xxx yards to go on an n^{th} hole”.

If the distance from the tee box to the hole cup is preliminarily calculated and stored in the memory 130, the distance calculation step may be omitted.

Meanwhile, when the user hits a ball on the tee box and then moves to the ball, the processor 140 may not search for a tee box on a specific hole in the detected golf course corresponding to the current location. In this case, when the user triggers the distance notification menu by pressing the keypad 120, the processor 140 may receive the coordinate data of the current location from the GPS receiver 110, calculate the distance from the current location to a hole cup using the coordinate data of the current location and coordinate data of the hole cup in the map data, and generate a distance notification message and output it through the audio output unit 160 by voice.

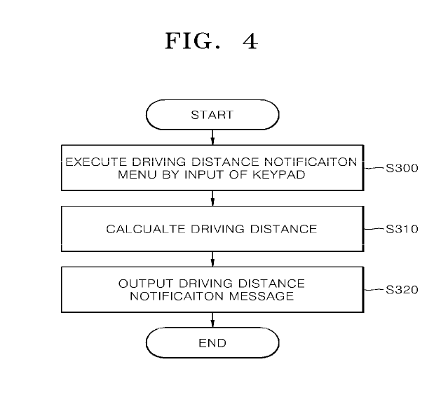

FIG. 4 is a flowchart illustrating an operation for executing a driving distance notification menu in the GPS-based portable golf distance indicator according to an embodiment of the present invention.

Referring to FIG. 4, the processor 140 stores position information about a location at which the distance notification menu was executed last time in the memory 130, for executing the driving distance notification menu.

If the user hits a ball and then executes the driving distance notification menu by pressing the keypad 120 at a spot where the ball falls down (S300), the processor 140 calculates the driving distance of the ball based on position information about a current location received from the GPS receiver 110 and position information about the location at which the distance notification menu was executed last time (S310). Subsequently, the processor 140 generates a driving distance notification message and outputs it through the audio output unit 160 by voice (S320). The driving distance notification message may say, for example, “You have driven xxx meters” or “You have driven xxx yards”.

The GPS-based portable golf distance indicator 100 may be configured so that different menus are executed by pressing different keys in the keypad 120 or by pressing the same key for different periods of time in the keypad 120. The keypad 120 may have various configurations depending on implementations.

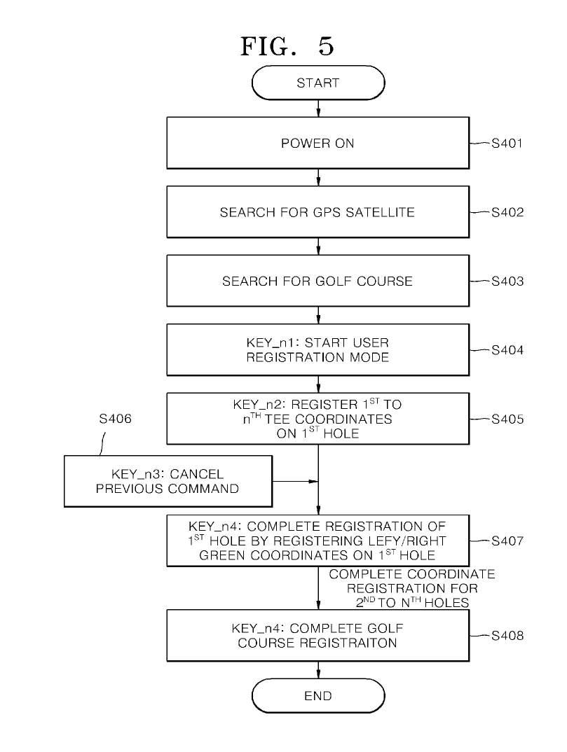

FIG. 5 is a flowchart illustrating a method for registering coordinates in the GPS-based portable golf distance indicator according to the embodiment of the present invention.

Referring to FIG. 5, when the GPS-based portable golf distance indicator 100 is powered on by the user's pressing of the keypad 120 (S401), the GPS receiver 110 searches for a GPS satellite (S402). Upon detection of the GPS satellite, the processor 140 receives coordinate data of a current location and searches for a golf course where the GPS-based portable golf distance indicator 100 is currently located in the map data using the received coordinate data of the current location (S403).

When the user presses a first key in the keypad 120, the processor 140 enters a user registration mode (S404). When the user presses a second key of the keypad 120 on a tee box, the processor 140 determines to perform a coordinate registration process on the tee box, receives coordinate data of a current location from the GPS receiver 110, and registers the received coordinate data as coordinate data of the tee box (S405). The coordinate registration is the process of updating the map data stored in the memory 130 to include the coordinate data of the tee box.

When the user has registered wrong coordinates, the user may cancel the coordinate registration by pressing a third key in the keypad 120 (S406).

Because a plurality of tee boxes may be placed on a single hole, the user may register the coordinates of the plurality of tee boxes by pressing the second key the plurality of times. In addition, when the user presses a fourth key in the keypad 120 at the location of a hole cup, the processor 140 determines to perform the coordinate registration process on the hole cup on a green, receives coordinate data of the hole cup from the GPS receiver 110, and registers the position of the hole cup on the left/right green on the first hole in the map data (S407).

The above operation is repeated for the second to N^{th} holes (S405, S406 and S407). When the user presses the first key in the keypad 120, the processor 140 ends the golf course registration process (S408).

While it has been described above that there are a plurality of keys, that is, the first to fourth keys in the keypad 120 in the embodiment of the present invention, which should not be construed as limiting the present invention, the number of keys in the keypad 120 may vary depending on an input scheme used. For example, the functions of the first to fourth keys may be realized by pressing a single key short, long, or short twice such as double clicking.

The above coordinate registration process includes substituting new coordinates of a tee box or a hole cup for existing coordinates of the tee box or the hole cup in the map data as well as registering the new coordinates in the absence of the coordinates of the tee box or the hole cup in the map data.

As the user registers the coordinates of target object locations using the GPS-based portable golf distance indicator 100 in this manner, the reliability of the map data can be increased.

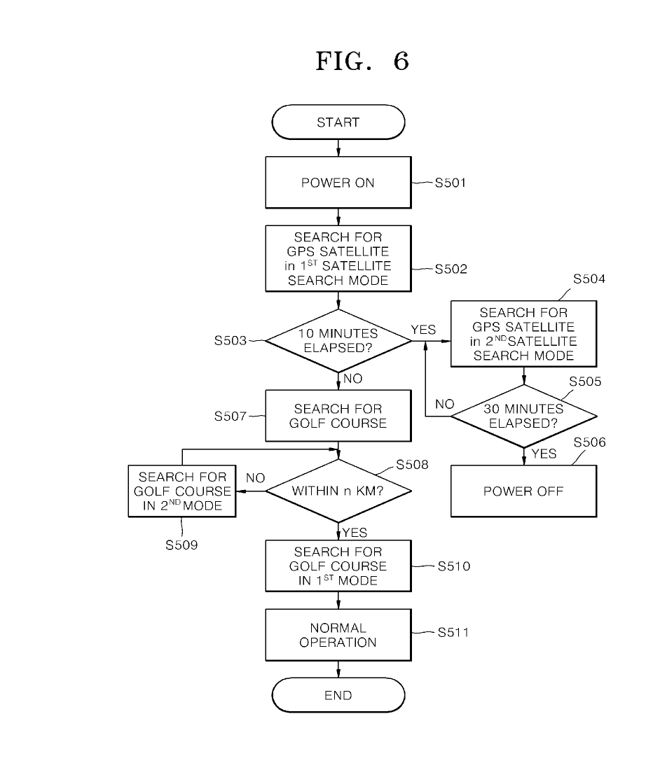

FIG. 6 is a flowchart illustrating a power saving method in the GPS-based portable golf distance indicator according to the embodiment of the present invention.

Referring to FIG. 6, when the GPS-based portable golf distance indicator 100 is powered on by the user's pressing of the keypad 120 (S501), the GPS receiver 110 searches for a GPS satellite in a first satellite search mode (S502). Then the processor 140 determines whether a first predetermined time (e.g. 10 minutes) has elapsed (S503). When the first predetermined time has elapsed, the GPS receiver 110 searches for the GPS satellite in a second satellite search mode (S504).

Then, the processor 140 determines whether a second predetermined time (e.g., 30 minutes) has elapsed (S505). If the second predetermined time has elapsed, the processor 140 performs turning off the GPS-based portable golf distance indicator 100 (S506). When the second predetermined time has not elapsed, the GPS receiver 110 continues searching for the GPS satellite in the second satellite search mode.

The first and second satellite search modes are set to have different periods in satellite searches of the GPS receiver 110. The GPS receiver 110 may have a longer search period in the second satellite search mode than in the first satellite search mode. Because the GPS receiver 110 has a long satellite search period at a location where the GPS satellite is not detected, the power consumption of the GPS-based portable golf distance indicator 100 can be minimized.

On the other hand, When the GPS receiver 110 detects the GPS satellite within the first predetermined time in the first satellite search mode, it searches for a golf course near to the current location of the GPS-based portable golf distance indicator 100 (S507). The processor 140 determines whether the current location is within a predetermined distance from the golf course (S508).

If the current location is not within the predetermined distance from the golf course, the processor 140 controls the GPS receiver 110 to search for the golf course in a second mode (S509).

On the other hand, When the current location is within the predetermined distance from the golf course, the processor 140 controls the GPS receiver 110 to search for the golf course in a first mode (S510) and controls a normal operation of the GPS-based portable golf distance indicator 100. The normal operation of the GPS-based portable golf distance indicator 100 includes the afore-described driving distance notification, current location-to-hole cup distance notification, or registration of the coordinates of target object locations.

The first and second modes are set to have different search periods in golf course search of the GPS receiver 110. That is, the GPS receiver 110 has a longer golf course search period in the second mode than in the first mode.

In step S509, the processor 140 may calculate an expected time to go from the current location to the golf course based on the distance from the current location to the golf course and a current velocity of the GPS-based portable golf distance indicator 100 and then may control the GPS receiver 110 to search for the golf course in the second mode during the expected time.

In addition, the processor 140 may set different location search periods for the GPS receiver 110 to operate during the time interval from identifying an N^{th} hole to identifying a tee box on the N^{th} hole and during the time interval from identifying the tee box on the N^{th} hole to identifying an (N+1)^{th} hole. For example, the processor 140 may control the GPS receiver 110 to detect a location in a normal mode from the time of identifying the N^{th} hole till the time of identifying the tee box on the N^{th} hole and in a power saving mode from the time of identifying the tee box on the N^{th} hole till the time of identifying the (N+1)^{th} hole.

The normal mode and the power saving mode differ in location search period. The location search period is longer in the power saving than in the normal mode.

Since the GPS receiver 110 operates in different golf course search modes according to current locations, the power consumption of the GPS-based portable golf distance indicator 100 can be minimized, when the GPS-based portable golf distance indicator 100 is activated at a far distance from a golf course.

In general, a golf game is played continuously across the 1^{st} to 18^{th} holes. When a golf player finishes his or her play on a current hole and then moves to the next hole, if a golf GPS terminal identifies the golf player as currently located in the vicinity of a tee box on the next hole, it notifies the distance from the current location to the hole cup on the next hole, determining that the play has been finished on the current hole and has started on the next hole. However, the golf GPS terminal may fail to identify the location of the golf player in the vicinity of the tee box. Thus, even though the golf player has already moved to the next hole and is playing golf on the next hole, the golf GPS terminal may notify the golf player of the distance to the hole cup on the previous hole, not on the next hole. Or the golf GPS terminal may have a GPS error by mistaking a tee box on another hole (3^{rd} to 18^{th} holes) for a tee box on the second hole.

In view of the nature of a golf play, a golfer enters the next hole after finishing a putting play on the green of a current hole. If the average time taken from reaching the green of the current hole to finishing putting a ball on the green is, e.g., 10 minutes, it may be determined that the golfer has entered the next hole irrespective of whether a tee box of the next hole is detected, upon expiration of 10 minutes after the golfer enters a green area of any hole. Then, the distance from the current location to the hole cup on the next hole may be calculated and then notified.

For this purpose, upon expiration of a predetermined time, starting from the moment the processor 140 determines that the coordinates of the current location is within a predetermined radius of the hole cup on the N^{th} hole including the current location, the processor 140 may perform a distance notification, considering that the golfer has entered the (N+1)^{th} hole. Meanwhile, to promote the registration of the coordinates of target object locations using the GPS-based portable golf distance indicator 100, map data sharing may be considered.

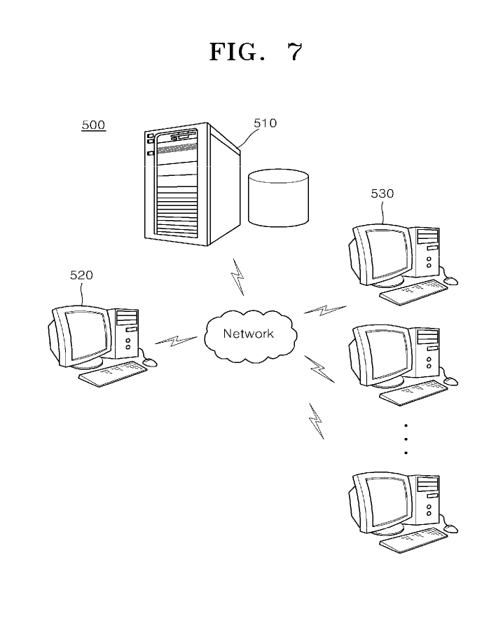

FIG. 7 illustrates a system for performing a map data sharing method according to another embodiment of the present invention.

Referring to FIG. 7, a system 500 for performing a map data sharing method includes a service server 510, a first user terminal 520, and second user terminals 530. The service server 510, the first user terminal 520, and the second user terminals 530 may be connected to one another through a network. The network may be a wired or wireless network over which signals can be transmitted and received.

The first and second user terminals 520 and 530 are devices capable of downloading map data from the GPS-based portable golf distance indicator 100 and uploading map data to the GPS-based portable golf distance indicator 100, such as a PC, a laptop computer, a tablet PC, a portable phone, a PMP, a smartphone, etc.

The first user terminal 520 may transmit map data to a plurality of second user terminals 530 through the service server 510. The service server 510 performs an open market service for sharing the map data.

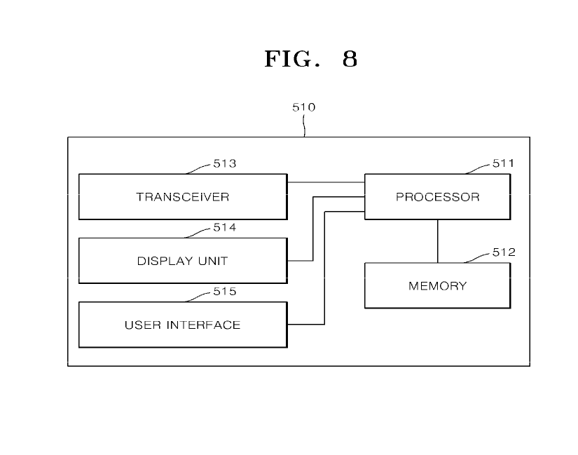

FIG. 8 is a block diagram of the service server for performing the map data sharing method according to another embodiment of the present invention.

Referring to FIG. 8, the service server 510 includes a processor 511, a memory 512, a transceiver 513, a display unit 514, and a user interface 115. The memory 512 is electrically connected to the processor 511 and stores an operating system, application programs, and data. The display unit 514 may display various types of information and may be configured with a known Liquid Crystal Display (LCD), Organic Light Emitting Diode (OLED), etc. The user interface 515 may be configured in combination with a known user interface such as a keyboard, a keypad, a touch screen, etc. The transceiver 513 is electrically connected to the processor 511 and transmits and receives signals.

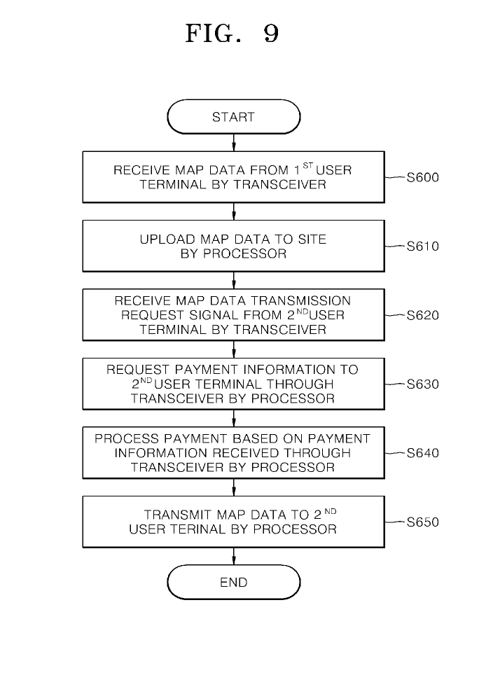

FIG. 9 is a flowchart illustrating the map data sharing method according to another embodiment of the present invention.

Referring to FIG. 9, the user may upload map data to which the coordinates of target object locations (e.g. the positions of tee boxes and hole cups) on a golf course using the GPS-based portable golf distance indicator 100 to the first user terminal 520 through the USB interface 180 of the GPS-based portable golf distance indicator 100, to which the present invention is not limited. In the case where GPS-based portable golf distance indicator 100 and the first user terminal 520 have wireless data transmission interfaces that operate in conformance with the Internet, Bluetooth, IR, Wireless Internet, etc., the map data can be transmitted in a wireless data transmission scheme, not through the USB interface 180.

After the user of the first user terminal 520 logs in to a sharing service site using his or her ID, the user may transmit the map data to which the user has registered the positions of target object locations by using the GPS-based portable golf distance indicator 100 to the service server 510 through the first user terminal 520.

Upon receipt of the map data from the first user terminal 520 at the transceiver 513 of the service server 510 (S600), the processor 511 uploads the map data to the sharing service site (S610). The sharing service site is a kind of open market site in which map data can be shared between users using GPS-based portable golf distance indicators 100 100 according the present invention.

When a user of a second user terminal 530 accesses the sharing service site and selects a download menu for the map data, the transceiver 513 of the service server 510 receives a map data transmission request signal from the second user terminal 530 (S620). To charge the user of the second user terminal 530 for the download of the map data, the processor 511 requests payment information to the second user terminal 530 through the transceiver 513 (S630).

Upon receipt of the payment information from the second user terminal 530 at the transceiver 513, the processor 511 processes the payment using the payment information (S640).

Upon completion of the payment process, the processor 511 transmits the map data to the second user terminal 530 through the transceiver 513 (S650).

Besides map data, the map data sharing method is applicable to voice data with which to generate a voice notification message. A user may generate voice data needed to output a voice notification message by male or female voice in each country's language, for example, in Korean, English, Japanese, Chinese, Latin, etc. in the GPS-based portable golf distance indicator 100 and then may update the voice data to the sharing service site using the user's terminal.

A voice data format in which the voice data is stored in the GPS-based portable golf distance indicator 100 for use in generating the voice notification message may be received from the sharing service site. Voice data formed in a plurality of languages may be stored in the memory 130 and the user may select and set voice data of an intended language by manipulating the keypad 120. The processor 140 may generate a voice notification message based on the selected voice data and output the voice notification message through the audio output unit 160.

However, the present invention is not limited to the above-described paid download service. Obviously, a free download service is also available in the present invention. In this case, the steps of requesting payment information and processing payment may be omitted.

The processor 511 may pay the user that uploaded the map data based on payment for downloads of the map data made for a predetermined time period.

A specific amount of cyber money may be deposited in an account corresponding to the ID of the upload user when the upload user logs in to the sharing service site. The user may download other map data or purchase goods in a shopping mall run by the site, with the cyber money.

As is apparent from the above description of the GPS-based portable golf distance indicator according to the embodiment of the present invention, since a user is allowed to directly register the coordinate data of important positions on a golf course during a golf play, the reliability of map data increases and thus the driving distance of a golf ball or the distance remaining to a hole cup can be notified with more accuracy.

As the power consumption of the GPS-based portable golf distance indicator is minimized, the GPS-based portable golf distance indicator can operate longer.

Due to continuous hole recognition, hole recognition errors can be minimized.

Further, the GPS-based portable golf distance indicator enables map data in which the coordinates of important locations on a golf course have been registered to be shared between users. Therefore, the coordinate registration of important locations on golf courses by users can be promoted.

Those skilled in the art will appreciate that the present invention may be carried out in other specific ways than those set forth herein without departing from the spirit and essential characteristics of the present invention. The above embodiments are therefore to be construed in all aspects as illustrative and not restrictive. The scope of the invention should be determined by the appended claims and their legal equivalents, not by the above description, and all changes coming within the meaning and equivalency range of the appended claims are intended to be embraced therein.

What is claimed is:

1. A Global Positioning System (GPS)-based portable golf distance indicator, comprising:
a GPS receiver for receiving a GPS signal from a GPS satellite and outputting coordinate data of a current location based on the received GPS signal;
a keypad for executing a driving distance notification menu for notifying a driving distance of a ball or a distance notification menu for notifying a distance from the current location to a hole cup or selecting a location registration menu;
a memory for storing map data of a golf course;
a processor for calculating and controlling; and
a power supply for supplying power to operate the GPS-based portable golf distance indicator,
wherein when the location registration menu is selected by an input of the keypad, the processor receives the coordinate data of the current location from the GPS receiver and updates the map data by registering coordinate data of a target object location on the golf course in the map data.

2. The GPS-based portable golf distance indicator according to claim 1, wherein the target object location is a location of a tee box or a location of a hole cup on an N^{th} hole of the golf course.

3. The GPS-based portable golf distance indicator according to claim 1, further comprising an audio output unit, wherein when the driving distance notification menu is executed by an input of the keypad, the processor calculates the driving distance of the ball using coordinate data of a first position based on a first input and coordinate data of a second position based on a second input, generates a voice notification message related to the calculated driving distance, and outputs the voice notification message through the audio output unit.

4. The GPS-based portable golf distance indicator according to claim 3, further comprising a Universal Serial Bus (USB) interface or a wireless data transmission interface, for transmitting the map data,
wherein the USB interface or the wireless data transmission interface receives voice data generated in a language of at least one country, for generating the voice notification message and stores the received voice data in the memory, and upon selection of voice data generated in a language of a country from among the voice data generated in the language of the at least one country, the processor generates the voice notification message based on the selected voice data.

5. The GPS-based portable golf distance indicator according to claim 1, further comprising a USB interface or a wireless data transmission interface, for transmitting the map data.

6. The GPS-based portable golf distance indicator according to claim 1, wherein upon expiration of a predetermined time after the processor initially determines that the current location is within a predetermined radius from a hole cup on an N^{th} hole including the current location, the processor sets the GPS-based portable golf distance indicator as moved to an (N+1)^{th} hole.

7. The GPS-based portable golf distance indicator according to claim 1, wherein when the current location is not within a predetermined radius from the golf course, the processor calculates an expected time to reach within the predetermined radius based on a current moving speed and sets the GPS-based portable golf distance indicator in a power saving mode for the expected time.

8. The GPS-based portable golf distance indicator according to claim 1, wherein the processor sets the GPS receiver to perform a location search in a normal mode from a time of identifying an N^{th} hole till a time of identifying an Nth tee box and in a power saving mode from the time of identifying the N^{th} tee box till a time of identifying an (N+1)^{th} hole, and
wherein the GPS receiver has a shorter location search period in the normal mode than in the power saving mode.

9. A method for sharing map data transmitted from the Global Positioning System (GPS)-based portable golf distance indicator of claim 5, comprising:
receiving the map data from a first user terminal to which the map data is transmitted via the USB interface or the wireless data transmission interface by a transceiver of the server;
uploading the received map data to a map data sharing site by a processor of a server;
receiving a map data transmission request signal from a second user terminal by the transceiver of the server; and
transmitting the map data to the second user terminal by the transceiver of the server.

10. The method according to claim 9, further comprising:
requesting payment information to the second user terminal through the transceiver of the server by a processor of the server;
processing, upon receipt of the payment information from the second user terminal at the transceiver of the server, payment using the received payment information by the processor of the server; and
storing information about the processed payment in a memory of the server by the processor of the server.

11. The method according to claim 10, further comprising:
receiving log-in information from the first user terminal by the transceiver of the server;
processing a log-in of the first user terminal by the processor of the server;
depositing cyber money into an account corresponding to an Identifier (ID) used for the log-in of the first user terminal, based on the information about the processed payment by the processor of the server; and
storing information about the deposited cyber money in the memory of the server by the processor of the server.
